(19) United States
(12) Patent Application Publication
(10) Pub. No.: US 2025/0321523 A1
(43) Pub. Date: Oct. 16, 2025

(54) IMAGE FORMING APPARATUS AND INFORMATION PROCESSING DEVICE

(71) Applicant: CANON KABUSHIKI KAISHA, Tokyo (JP)

(72) Inventors: ATSUSHI MATSUMOTO, Ibaraki (JP); TOSHIYUKI YAMADA, Tokyo (JP); MASAMI HANO, Chiba (JP); MARIKO SAKAMOTO, Chiba (JP); KOTA MORI, Chiba (JP); KYOHEI KIKUCHI, Ibaraki (JP)

(21) Appl. No.: 19/173,001

(22) Filed: Apr. 8, 2025

(30) Foreign Application Priority Data
Apr. 12, 2024 (JP) 2024-064418

(51) Int. Cl. G03G 15/00; G03G 15/23

(52) U.S. Cl. CPC G03G 15/502; G03G 15/234; G03G 15/6591; G03G 2215/00493; G03G 2215/00586

(57) ABSTRACT

An image forming apparatus includes a selector configured to select a first mode for forming an image on a first recording material including a first side which is closed, a second side which is closed, a third side which is open, and a fourth side which is open, a placement portion on which the first recording material is to be placed, an image former configured to form an image on the first recording material conveyed from the placement portion, and a display, wherein the display is configured to display, in a case where the first mode is selected by the selector, a message prompting a user to place the first recording material on the placement portion so that a leading edge side of the first recording material in a conveyance direction becomes the first side.

### BACKGROUND OF THE INVENTION

### Field of the Invention

The present disclosure relates to an image forming apparatus which forms an image on a recording material by using an electrophotographic method or an electrostatic recording method.

### Description of the Related Art

An image forming apparatus generally prints images using paper, for example, defined in the Japanese Industrial Standards as a recording material. The image forming apparatus can use various sizes and types of paper or a document folder as the recording material. In Japanese Patent Application Laid-open No. 2011-168394, an image forming apparatus which conveys a document folder is disclosed.

A document folder has a shape in which at least one side is closed and at least one side is open. In a case where an image is formed on a recording material having such a shape, there is a possibility that a conveyance failure of the recording material may occur depending on the orientation in which the recording material is conveyed.

### SUMMARY OF THE INVENTION

An image forming apparatus according to one embodiment of the present disclosure includes a selector configured to select a first mode for forming an image on a first recording material including a first side which is closed, a second side which is closed, a third side which is open, and a fourth side which is open, a placement portion on which the first recording material is to be placed, an image former configured to form an image on the first recording material conveyed from the placement portion, and a display, wherein the display is configured to display, in a case where the first mode is selected by the selector, a message prompting a user to place the first recording material on the placement portion so that a leading edge side of the first recording material in a conveyance direction becomes the first side.

An information processing device which is operable to communicate with an image forming apparatus according to another embodiment of the present disclosure includes a placement portion on which a recording material is to be placed, and an image former configured to form an image on the recording material conveyed from the placement portion, the information processing device includes a selector configured to select a first mode for forming an image on a first recording material including a first side which is closed, a second side which is closed, a third side which is open, and a fourth side which is open, and a display, wherein the display is configured to display, in a case where the first mode is selected by the selector, a message prompting the user to place the first recording material on the placement portion so that a leading edge side of the first recording material in a conveyance direction becomes the first side.

Further features of the present invention will become apparent from the following description of exemplary embodiments (with reference to the attached drawings).

### BRIEF DESCRIPTION OF THE DRAWINGS

FIG. 1 is a configuration view of an image forming system.

FIG. 2 is an explanatory diagram of a main controller.

FIG. 3 is a configuration explanatory view of an operation unit.

FIG. 4 is a configuration view of an image forming apparatus.

FIG. 5 is an exemplary view of a sheet type selection screen.

FIG. 6 is a flowchart for illustrating processing from setting of the sheet type to starting image formation.

FIG. 7 is an exemplary view of a setting screen of a feeding location for a document folder.

FIG. 8 is an exemplary view of a guide screen for illustrating a precaution.

FIG. 9A and FIG. 9B are views of a modification example of the guide screen.

FIG. 10 is an explanatory diagram of creasing of a document folder.

FIG. 11 is an explanatory diagram of creasing of a document folder.

FIG. 12 is an explanatory diagram of a placement state on a tray.

FIG. 13 is an exemplary view of a guide screen for illustrating another precaution.

FIG. 14 is an exemplary view of a simplex/duplex setting screen.

FIG. 15 is an exemplary view of an instruction screen.

FIG. 16 is an exemplary view of a setting screen of a normal feeding location.

FIG. 17 is an exemplary view of a duplex printing selection screen.

FIG. 18 is a flowchart for illustrating processing from setting of the sheet type to starting image formation.

FIG. 19 is an exemplary view of a guide screen for illustrating a precaution.

FIG. 20 is an exemplary view of the guide screen.

FIG. 21 is an exemplary view of the simplex/duplex setting screen for a document folder.

FIG. 22 is an exemplary view of the guide screen.

### DESCRIPTION OF THE EMBODIMENTS

Now, referring to the accompanying drawings, description is given of at least one exemplary embodiment of the present disclosure. In the at least one embodiment, description of an electrophotographic image forming apparatus is given as an example, but the present disclosure is effective even for other types of image forming apparatus, such as an inkjet type apparatus.

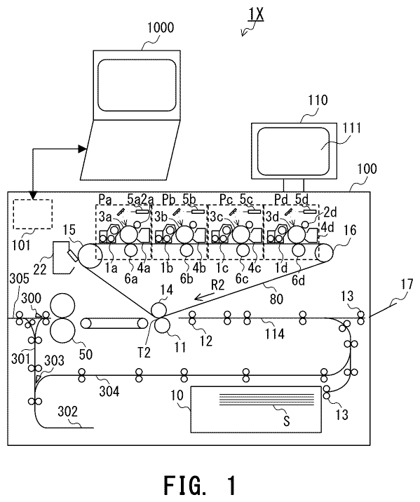

FIG. 1 is a configuration view of an image forming system including an image forming apparatus according to the at least one embodiment. An image forming system 1X includes an image forming apparatus 100 which forms a toner image on a recording material S, and an operation unit 110 which has a display 111.

The image forming apparatus 100 according to the at least one embodiment is an electrophotographic tandem full-color printer. The image forming apparatus 100 may be configured to form images using an electrostatic recording method. The image forming apparatus 100 includes an image forming unit Pa, as an image former, for forming a yellow image, an image forming unit Pb for forming a magenta image, an image forming unit Pc for forming a cyan image, and an image forming unit Pd for forming a black image.

The image forming apparatus 100 forms a toner image on the recording material S based on data relating to the toner image included in image data, which is acquired from an external device 1000 such as an original reading apparatus (not shown) or a personal computer communicably connected to the image forming apparatus 100, for example. Examples of materials that can be used as the recording material S include a sheet material made of paper, such as general plain paper, cardboard, rough paper, textured paper, and coated paper, as well as, in the at least one embodiment, a document folder having a bag shape formed from a sheet material made of plastic.

Description is now given of a conveyance process of the recording material S. The recording material S is accommodated and placed in a cassette 10, or is placed on a tray 17. The recording material S is fed from the cassette 10 or the tray 17 by feed rollers 13 in accordance with the image forming timing. The tray 17 is provided so as to be openable and closable by a user, for example. The recording material S fed by the feed rollers 13 is conveyed to registration rollers 12 arranged along a conveyance path 114. The registration rollers 12 perform skew correction and timing correction, and then convey the recording material S to a secondary transfer unit T2. The secondary transfer unit T2 is a transfer nip unit formed by an inner secondary transfer roller 14 and an outer secondary transfer roller 11. The secondary transfer unit T2 transfers the toner image onto the recording material S by applying a secondary transfer voltage to the outer secondary transfer roller 11.

Description is now given of the image forming process in which the toner image is conveyed to the secondary transfer unit T2 at the same timing relative to the process of conveying the recording material S to the secondary transfer unit T2. Description is given of the configuration of the image forming units Pa, Pb, Pc, and Pd. The image forming units Pa, Pb, Pc, and Pd have substantially the same configuration, except that the colors of the images (toner images) to be formed are different among yellow, magenta, cyan, and black. Here, description is given of the image forming unit Pd which forms a black toner image, and description of the other image forming units Pa, Pb, and Pc is omitted.

The image forming unit Pd mainly includes a developing device 1d, a charging device 2d, a photosensitive drum 3d, a photosensitive drum cleaner 4d, an exposure device 5d, a primary transfer roller 6d, and the like. The photosensitive drum 3d is a photosensitive member having a photosensitive layer on a surface, and is rotated around a drum shaft. The charging device 2d uniformly charges the surface of the photosensitive drum 3d being rotated. The exposure device 5d forms an electrostatic latent image by irradiating the charged surface of the photosensitive drum 3d with a laser beam which is driven based on an image signal. The developing device 1d forms a black toner image on the surface of the photosensitive drum 3d by using a developer to develop the electrostatic latent image formed on the photosensitive drum 3d.

The primary transfer roller 6d is provided so as to sandwich an intermediate transfer belt 80 at a position opposing the photosensitive drum 3d. The primary transfer roller 6d transfers the toner image formed on the photosensitive drum 3d onto the intermediate transfer belt 80 by applying a primary transfer voltage. Transfer residual toner remaining on the photosensitive drum 3d after the transfer is collected by the photosensitive drum cleaner 4d.

In the same manner, a yellow toner image is formed on a photosensitive drum 3a of the image forming unit Pa, and the toner image is transferred onto the intermediate transfer belt 80 by a primary transfer roller 6a. A magenta toner image is formed on a photosensitive drum 3b of the image forming unit Pb, and the toner image is transferred onto the intermediate transfer belt 80 by a primary transfer roller 6b. A cyan toner image is formed on a photosensitive drum 3c of the image forming unit Pc, and the toner image is transferred onto the intermediate transfer belt 80 by a primary transfer roller 6c.

The intermediate transfer belt 80 is an endless belt stretched around the inner secondary transfer roller 14 and tensioning rollers 15 and 16, and is driven in the direction of an arrow R2. In the at least one embodiment, the tensioning roller 16 also serves as a drive roller which drives the intermediate transfer belt 80. The image forming process of each of the image forming units Pa to Pd is performed at a timing such that the transferred toner images of the respective colors are sequentially superimposed on the intermediate transfer belt 80. As a result, in the end, a full-color toner image is formed on the intermediate transfer belt 80.

The intermediate transfer belt 80 conveys the toner image to the secondary transfer unit T2 by rotating. Conveyance of the toner image to the secondary transfer unit T2 is performed in accordance with the timing at which the recording material S is conveyed to the secondary transfer unit T2. As a result, the toner image is transferred onto a predetermined position on the recording material S. Transfer residual toner remaining on the intermediate transfer belt 80 after the transfer by the secondary transfer unit T2 is removed by a transfer cleaner 22.

The toner image is borne on the recording material S by a conveyance process and an image forming process such as those described above. The recording material S is conveyed from the secondary transfer unit T2 to a fixing device 50. The fixing device 50 fixes the toner image on the recording material S by applying heat and pressure to the recording material S bearing the toner image. For this purpose, the fixing device 50 has a first roller that includes a built-in heat source and a second roller that is biased toward the first roller, and conveys the recording material S by sandwiching the recording material S between the first roller and the second roller. At this time, the recording material S is heated by the heat source and pressed by the second roller. As a result, each toner image borne by the recording material S is melted and mixed, and is fixed on the recording material S as a full-color image.

The recording material S on which the image has been fixed is guided by a flapper 300 to any one of a conveyance path 301 and a conveyance path 305. The flapper 300 guides the recording material S to the conveyance path 305 in a case where the printing surface (image forming surface) is not reversed in simplex printing and in a case where printing on both surfaces is finished in duplex printing. The recording material S guided to the conveyance path 305 is delivered to outside the image forming apparatus 100.

The flapper 300 guides the recording material S to the conveyance path 301 in a case where printing on the front surface (first surface) is finished in duplex printing and in a case where the printing surface is reversed in simplex printing. The recording material S is conveyed to a reversing unit 302 via the conveyance path 301. The conveyance direction of the recording material S conveyed to the reversing unit 302 is reversed, and the recording material S is guided by the flapper 303 to any one of the conveyance path 301 and a duplex-printing conveyance path 304. Through reversing the conveyance direction by the reversing unit 302 and conveying the recording material S to the conveyance path 301 or the duplex-printing conveyance path 304, the printing surface of the recording material S is reversed.

The flapper 303 guides the recording material S to the conveyance path 301 when reversing the printing surface in simplex printing. The recording material S guided to the conveyance path 301 is delivered from the conveyance path 301 to outside the image forming apparatus 100 via the conveyance path 305. The flapper 303 guides the recording material S to the duplex-printing conveyance path 304 in a case where duplex printing on the front surface is finished. The recording material S guided to the duplex-printing conveyance path 304 is conveyed to the secondary transfer unit T2. As a result, an image is printed on the back surface (second surface) of the recording material S.

The developer to be used in the at least one embodiment is a two-component developer containing a toner and a carrier. The toner contains a binder resin, a colorant, and a release agent (wax). A publicly-known binder resin may be used as the binder resin. For example, a vinyl-based copolymer typified by a styrene-(meth) acrylic copolymer, a polyester resin, a hybrid resin in which a vinyl-based copolymer unit and a polyester unit are chemically bonded to each other, an epoxy resin, or a styrene-butadiene copolymer may be used as the binder resin. A publicly-known colorant may be used as a colorant for each of the colors of yellow, magenta, cyan, and black.

For example, an aliphatic hydrocarbon-based wax or an oxide of an aliphatic hydrocarbon-based wax, or a block copolymerized product thereof may be used as the release agent. The aliphatic hydrocarbon-based wax is, for example, low-molecular-weight polyethylene, a low-molecular-weight olefin copolymer wax, a microcrystalline wax, a Fischer-Tropsch wax, or a paraffin wax. The oxide of the aliphatic hydrocarbon-based wax is, for example, a polyethylene oxide wax. The block copolymerized product is a wax containing a fatty acid ester as a main component, an ester wax, or a product obtained by deacidifying part or whole of a fatty acid ester such as deacidified carnauba wax. Examples of the wax containing a fatty acid ester as a main component include a carnauba wax and a montanoic acid ester wax. The ester wax is, for example, a synthesis reaction product of a higher fatty acid and a higher alcohol, such as behenyl behenate or behenyl stearate.

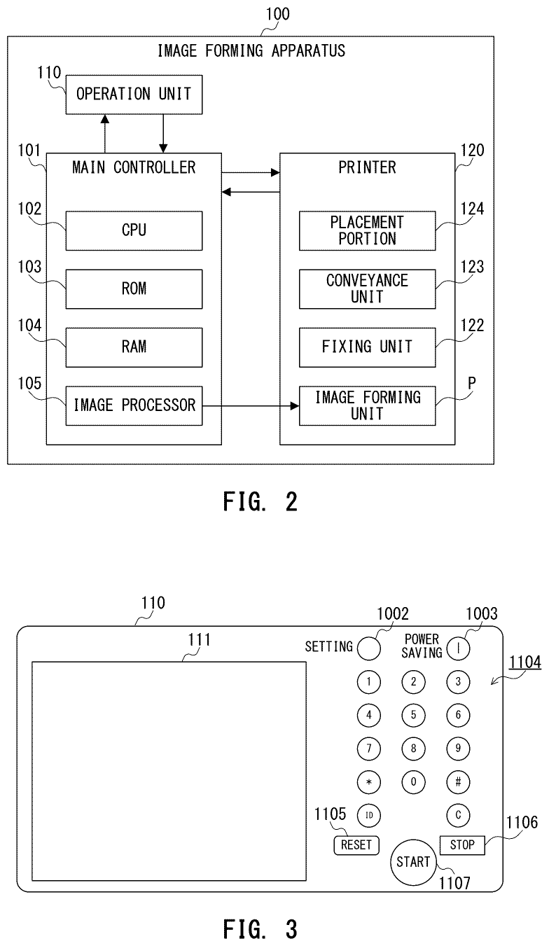

Operation of such an image forming apparatus 100 is controlled by a main controller 101. FIG. 2 is an explanatory diagram of the main controller 101. The main controller 101 can communicate to and from a printer 120 and the operation unit 110. The printer 120 includes various units used in, for example, the conveyance process and the image forming process described above.

The main controller 101 includes a central processing unit (CPU) 102, a read-only memory (ROM) 103, a random-access memory (RAM) 104, and an image processor 105. The CPU 102 controls the overall operation of the image forming system 1X by executing computer programs stored in the ROM 103. The RAM 104 provides a work area in a case where the CPU 102 executes processing. The image processor 105 transmits, to the image forming units Pa to Pd, an image signal generated by performing predetermined image processing on image data acquired from the external device 1000, such as converting the image data into a format that can be processed by exposure devices 5a to 5d of the image forming units Pa to Pd.

The printer 120 includes a placement portion 124, a conveyance unit 123, a fixing unit 122, and an image forming unit P. The image forming unit P represents the above-mentioned image forming units Pa to Pd. The placement portion 124 is the cassette 10 and the tray 17, and the recording material S is accommodated or placed therein. The conveyance unit 123 feeds the recording material S from the placement portion 124, conveys the recording material S to the secondary transfer unit T2 and the fixing device 50, and delivers the recording material S to outside the image forming system 1X. The conveyance unit 123 includes the feed rollers 13 and the registration rollers 12. The fixing unit 122 is the above-mentioned fixing device 50, and fixes the toner image on the recording material S. The image forming unit P includes the image forming units Pa to Pd which form the toner images of the respective colors as described above. The image forming unit P controls the drive of the laser beams output from the exposure devices 5a to 5d based on the image signal acquired from the image processor 105.

In order to perform optimal print settings, the image forming apparatus 100 according to the at least one embodiment is required to set the sheet type based on an instruction from the user by using the operation unit 110. The operation unit 110 is a user interface having the display 111 being an input interface and an output interface. The operation unit 110 is used, for example, to acquire the sheet type setting of the recording material S used for image formation. FIG. 3 is a configuration explanatory view of the operation unit 110.

The operation unit 110 in the at least one embodiment has, as input interfaces, a setting key 1002, a power saving key 1003, a hard key group 1104, a reset key 1105, a stop key 1106, and a start key 1107. Further, the operation unit 110 may include a touch panel provided on the display 111 as an input interface. Content (for example, information required for creating job information such as the type of the recording material S, the number of print copies, and output attribute information) input by using the input interfaces is transmitted to the CPU 102. The user can input information by using the input interfaces.

The setting key 1002 is pressed in a case where various settings such as the sheet type setting are performed. The power saving key 1003 is pressed in a case where the image forming apparatus 100 is set to a sleep mode or the image forming apparatus 100 is woken up from the sleep mode. The image forming apparatus 100 transitions to the sleep mode in a case where the power saving key 1003 is pressed in a normal mode, and transitions to the normal mode in a case where the power saving key 1003 is pressed in the sleep mode. The hard key group 1104 includes a numeric keypad, a clear key, and an authentication key. The reset key 1105 is pressed in a case where various settings are reset. The stop key 1106 is pressed in a case where an operation in progress is stopped. The start key 1107 is pressed in a case where a printing operation is started or in a case where another function is instructed to start. The start key 1107 includes two-color light emitting diodes (LEDs), which are green and red LEDs (not shown). In a case where the start key 1107 is lit in green, this indicates that it is possible to start, and in a case where the start key 1107 is lit in red, this indicates that it is not possible to start.

The various keys described above are hardware keys, but those various keys may be implemented by software keys displayed on the display 111. Further, the various keys may be implemented by combining hardware keys and software keys.

### <Examples of Other Image Forming Apparatus>

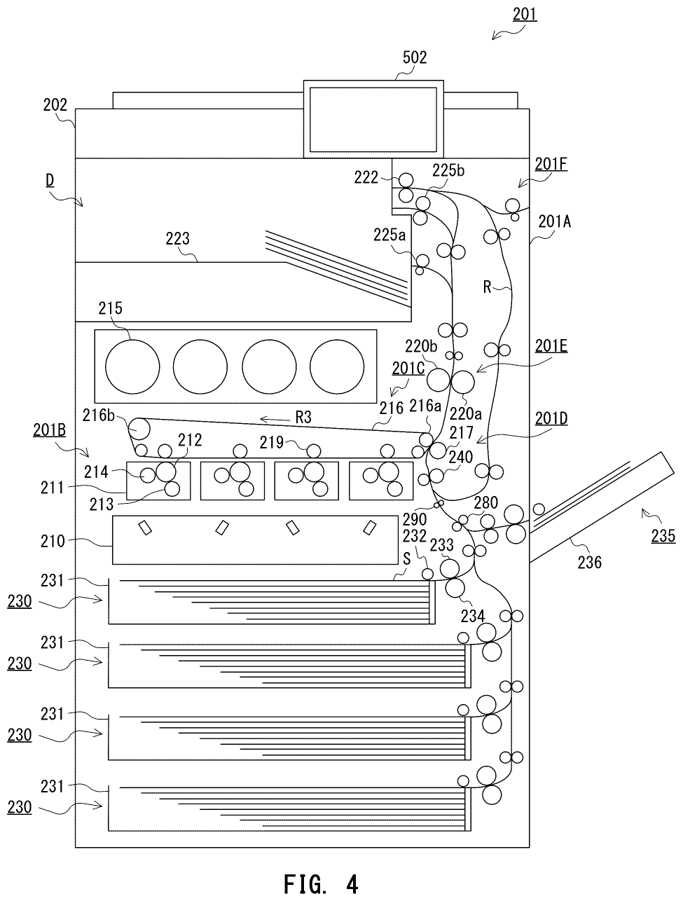

The image forming apparatus 100 described with reference to FIG. 1 prints an image while conveying the recording material S in a horizontal direction parallel to the lower surface of the image forming apparatus 100. That is, the conveyance path 114 along which the recording material S is conveyed is a horizontal path extending in the horizontal direction. Among image forming apparatus, there are image forming apparatus which print images while conveying the recording material S in a perpendicular direction (vertical direction) orthogonal to the lower surface of the image forming apparatus (vertical path). FIG. 4 is a configuration view of such an image forming apparatus. An image forming apparatus 201 is, for example, a laser beam printer of a tandem intermediate-transfer type using an electrophotographic process. The image forming apparatus 201 forms a full-color image or a monochrome image on a recording material S being a recording medium and outputs the recording material S based on image data acquired from an external device 1000 (see FIG. 1) via a network or based on image data acquired from an image reading device 202 which is provided on the top of the image forming apparatus 201.

The image forming apparatus 201 has, inside a main body 201A, components for forming an image, and includes, on the top of the main body 201A, the image reading device 202 and an operation unit 502 having the same configuration as the operation unit 110 of FIG. 1. A delivery space D including a placement portion 223 for receiving the recording material S to be delivered thereinto after image formation is defined between the main body 201A of the image forming apparatus 201 and the image reading device 202.

The image reading device 202 is a scanner which reads an image from an original to generate image data. The image reading device 202 is used, for example, at the time of processing of copying an original. The image reading device 202 in the at least one embodiment is configured as a part of the image forming apparatus 201. The image reading device 202 is not limited to this configuration, and the image reading device 202 may be configured to be electrically connected to the image forming apparatus 201 as a device different from the image forming apparatus 201.

The image forming apparatus 201 includes, in the main body 201A, an image forming mechanism 201B, an intermediate transfer unit 201C, a secondary transfer unit 201D, a fixing device 201E, and cassette feeding units 230. The main body 201A includes a manual feeding unit 235.

The cassette feeding units 230 each feed recording materials S from a corresponding one of feeding cassettes 231 accommodating the recording materials S. The cassette feeding unit 230 includes a pickup roller 232 and a separation unit for separating recording materials S sent out from the pickup roller 232. The separation unit includes a feed roller 233 and a retard roller 234. The recording materials S are fed one by one from the feeding cassette 231 by the pickup roller 232 and the separation unit. In the at least one embodiment, description is given of a configuration in which a plurality of (in this example, four) cassette feeding units 230 are provided. However, any number of cassette feeding units 230 may be provided. The recording material S fed from the cassette feeding unit 230 is conveyed to registration rollers 240 via conveyance rollers 280 and 290.

The recording material S can be fed from a unit other than the cassette feeding unit 230, that is, from the manual feeding unit 235. The manual feeding unit 235 includes a tray 236 for receiving recording materials S manually placed by the user. Similar to the cassette feeding unit 230, the manual feeding unit 235 includes a pickup roller and a separation unit, and recording materials S are fed one by one from the tray 236. The recording material S fed from the manual feeding unit 235 is also conveyed to the registration rollers 240 via the conveyance rollers 280 and 290.

The image forming mechanism 201B is of a four-drum full-color type, and includes a laser scanner 210 and four image forming units 211. The four image forming units 211 form toner images of four colors, specifically, yellow (Y), magenta (M), cyan (C), and black (K). Each image forming unit 211 includes a photosensitive drum 212, a charging device 213, and a developing device 214. Toner cartridges 215 are arranged above the image forming units 211. The toner cartridges 215 replenish the respective developing devices 214 with toner.

The intermediate transfer unit 201C includes an intermediate transfer belt 216 wound around a drive roller 216a and a tension roller 216b. On an inner side of the intermediate transfer belt 216, there are provided four primary transfer rollers 219 which are in abutment against the intermediate transfer belt 216 at positions opposing the photosensitive drums 212. The intermediate transfer belt 216 is rotated in the direction of an arrow R3 by the drive roller 216a driven by a drive unit (not shown).

The secondary transfer unit 201D includes a secondary transfer roller 217 provided so as to sandwich the intermediate transfer belt 216 at a position opposing the drive roller 216a. The fixing device 201E is provided on a downstream side of the secondary transfer roller 217 in the conveyance direction of the recording material S, and includes a pressure roller 220a and a heating roller 220b. On a downstream side of the fixing device 201E in the conveyance direction of the recording material S, there are arranged first delivery rollers 225a, second delivery rollers 225b, and a duplex-printing reversing unit 201F. The duplex-printing reversing unit 201F includes reversing rollers 222 and a re-conveyance passage R. The reversing rollers 222 are rotatable in forward and reverse directions. The re-conveyance passage R allows the recording material S having an image formed on one side thereof to be conveyed to the image forming mechanism 201B.

The image forming apparatus 201 having the configuration as described above operates as follows. The image forming apparatus 201 acquires, together with an instruction to start a print job, image data from the image reading device 202 or from the external device 1000 and forms an image corresponding to the image data on the recording material S. A print job is a series of operations performed based a print signal instructing an image to be formed on the recording material S, in which a conveyance process and an image forming process are executed, and after the image printing is complete, the recording material S is delivered to the placement portion 223. The image forming apparatus 201 acquires the instruction to start the print job from the operation unit 502 or the external device 1000.

The image forming mechanism 201B uses the charging device 213 to uniformly charge surfaces of the photosensitive drums 212 to an electric potential having a predetermined polarity. The laser scanner 210 irradiates the uniformly charged surfaces of the photosensitive drums 212 with corresponding laser beams modulated based on the image data. In this way, electrostatic latent images for corresponding colors (yellow, magenta, cyan, and black) are formed on the respective surfaces of the photosensitive drums 212.

The image forming mechanism 201B uses the developing devices 214 to develop the electrostatic latent images formed on the photosensitive drums 212. The electrostatic latent images are developed on the photosensitive drums 212 with toners of corresponding colors so that toner images of the corresponding colors are formed on the photosensitive drums 212. The toner images are sequentially transferred from the photosensitive drums 212 to the rotating intermediate transfer belt 216 in superimposition by the primary transfer rollers 219. In this way, a full-color toner image is formed on the intermediate transfer belt 216. The intermediate transfer belt 216 rotates to convey the toner image to the secondary transfer unit 201D.

Concurrently with such operation of forming a toner image, the recording materials S are conveyed one by one by the cassette feeding unit 230 or the manual feeding unit 235 to the registration rollers 240. The registration rollers 240 correct skew of the recording material S conveyed to the registration rollers 240. After the skew is corrected, the recording material S is conveyed by the registration rollers 240 to the secondary transfer unit 201D in synchronization with the timing at which the toner image borne on the intermediate transfer belt 216 is conveyed to the secondary transfer unit 201D. The secondary transfer unit 201D transfers the full-color toner image from the intermediate transfer belt 216 onto the recording material S with secondary transfer bias applied to the secondary transfer roller 217.

The recording material S having the toner image transferred thereto is conveyed to the fixing device 201E. The fixing device 201E sandwiches and conveys the recording material S with a roller nip portion defined by the pressure roller 220a and the heating roller 220b. The fixing device 201E heats the recording material S with the heating roller 220b at the time of sandwiching and conveying the recording material S, to thereby melt and mix the toners of respective colors on the recording material S. Further, the fixing device 201E presses the recording material S with the pressure roller 220a, to thereby fix the melted and mixed toners to the recording material S. At this time, the viscosity of the melted toner generates a sticking force to the heating roller 220b on the recording material S.

The recording material S having the image fixed thereto is delivered to the delivery space D by any one of the first delivery rollers 225a and the second delivery rollers 225b. The recording material S is placed on the placement portion 223 provided in a protruding manner on a bottom surface of the delivery space D. In a case where images are formed on both surfaces of the recording material S, the recording material S having an image fixed on one surface thereof is conveyed by the reversing rollers 222 to the re-conveyance passage R. The recording material S is conveyed again to the image forming mechanism 201B, and an image is formed on another surface of the reversed recording material S. The re-conveyance passage R allows the recording material S to be conveyed to the conveyance path between the conveyance roller 290 and the registration rollers 240.

In this way, in the image forming apparatus 201, the recording material S is conveyed along a conveyance path (vertical path) extending in the vertical direction. During image formation, the recording material S is conveyed from a lower side toward an upper side in the vertical direction from the registration rollers 240 to the fixing device 201E, with the upper side as the leading edge. When conveyed through the re-conveyance passage R, the recording material S is conveyed from the upper side toward the lower side in the vertical direction, with the lower side as the leading edge.

Operation of the image forming apparatus 201 is controlled by the main controller 101, which is the same as that illustrated in FIG. 2. In this case, the placement portion 124 of the printer 120 includes the cassette feeding units 230 and the manual feeding unit 235. The conveyance unit 123 includes various rollers such as the conveyance rollers 280 and 290, and the registration rollers 240. The fixing unit 122 includes the fixing device 201E. The image forming unit P includes the image forming unit 211.

The recording material S used for printing in the image forming apparatus 100 and 201 as described above may use, as described above, in addition to a sheet in which paper is used, a document folder formed in a bag shape by folding a sheet material of a plastic material. The document folder has, for example, at least one side open and the remaining sides (edges) closed among a plurality of sides (edges) overlapping by folding a sheet material of a plastic material. The open side (edge) is referred to as “open portion,” and the closed side (edge) is referred to as “fixed portion.” The fixed portion includes a folded portion formed by folding the plastic material, and a closed portion in which the side (edge) has been fixed by a welding method using heat or ultrasonic waves or by a bonding method using an adhesive, for example. Normally, two sides of the document folder are fixed and closed, and the remaining two sides are open.

In a case where a document folder is conveyed, conveyance failure may occur due to the shape of the document folder. For example, when there is a bent portion in the conveyance path, a crease may occur in the folded portion of the document folder in a direction intersecting the fold line due to an external force generated at the bent portion during conveyance. In addition, when the document folder is conveyed with the open portion as the leading edge in the conveyance direction, the edge of the document folder may become open. This may reduce the conveyance speed of the document folder and cause a conveyance failure such as jamming to occur. Through appropriate setting of the orientation and passage conditions when passing the document folder, it is possible to prevent the occurrence of such a conveyance failure. However, for a user who is using a document folder as the recording material S for the first time, it is difficult to appropriately set the orientation and passage conditions when passing the document folder.

### First Embodiment

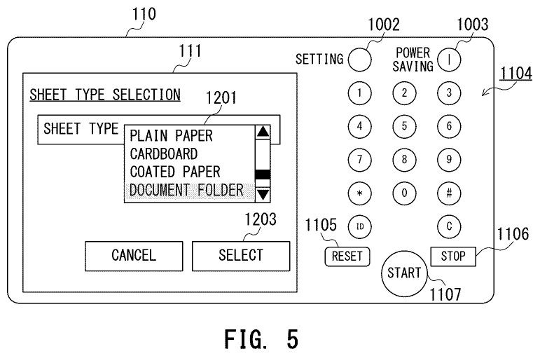

In a first embodiment of the present disclosure, printing on a document folder is possible by selecting the type of sheet (recording material S) to be used for printing from a sheet type selection screen. In the first embodiment, in a case where document folder is set as the sheet type, a conveyance failure countermeasure corresponding to document folder is performed to prevent creasing of the recording material S (document folder), which is one conveyance failure of document folders. FIG. 5 is an exemplary view of the sheet type selection screen. A selection screen 1201 is displayed on the display 111. On the selection screen 1201, the recording material S type can be freely selected, and document folder is provided as one of those freely-selectable sheet types.

In a case where the user selects and presses document folder from a pull-down menu on the selection screen 1201, the selected portion is displayed with its background being highlighted. In a case where the user subsequently presses a select button 1203, the selection of document folder as the sheet type is input to the main controller 101. The CPU 102 thereby sets the type of the recording material S to document folder.

Setting information (image forming conditions) corresponding to document folder to be used at the time of image formation to prevent deterioration in conveyance performance and image quality is stored in the ROM 103 in advance. The CPU 102 acquires the setting information on document folder from the ROM 103, and uses the acquired setting information for control during image formation by the printer 120. As a result, deterioration in conveyance performance and image quality in a case where printing on a document folder is prevented.

In the first embodiment, creasing of the recording material S (document folder), which is an example of a specific conveyance failure, is prevented by displaying a guide screen which alerts the user when placing the recording material S. On the guide screen, guidance is provided for the feeding location (placement portion 124) of the recording material S (document folder) and the orientation of the recording material S (document folder) at the time of placement.

FIG. 6 is a flowchart for illustrating processing from setting of the sheet type to starting image formation. Here, description is given of processing executed in a case where the image forming apparatus 100 is used, but the same processing is possible in a case where the image forming apparatus 201 is used.

The main controller 101 displays the sheet type selection screen 1201 of FIG. 5 on the display 111 (Step S101). The selection screen 1201 is displayed in a case where the user presses a button to start selecting the sheet type, or in a case where the user places the recording material S on the cassette 10 or the tray 17. As described above, in a case where the user selects the sheet type from the selection screen 1201 and presses the select button 1203, the main controller 101 sets the type of the recording material S. The main controller 101 determines whether or not document folder is set as the type of the recording material S (Step S102). A case in which document folder is set is referred to as “first mode,” and a case in which a single sheet not having a fixed portion and an open portion other than a document folder is set is referred to as “second mode.”

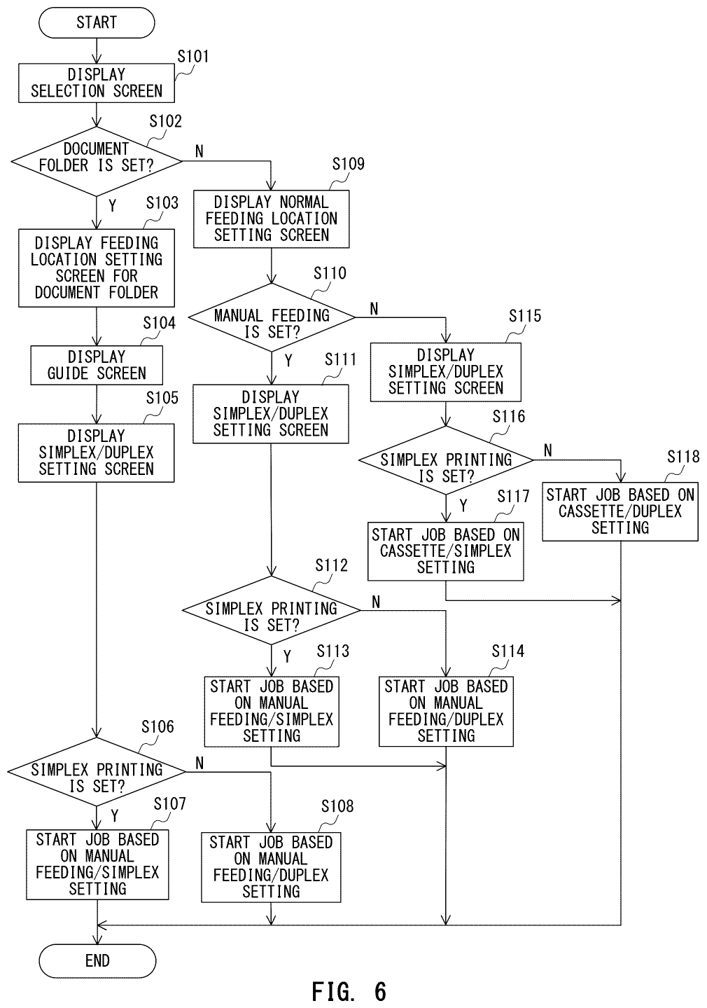

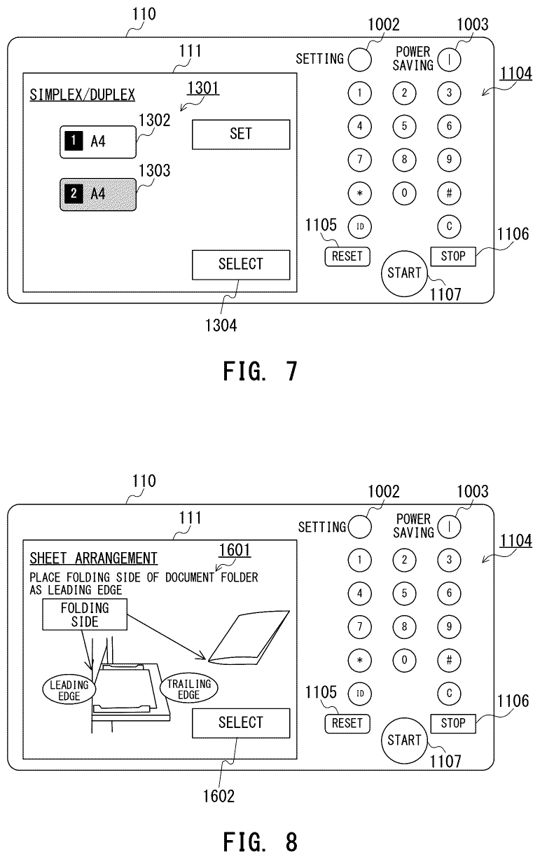

In a case where document folder is set (Step S102: Y), the main controller 101 displays the feeding location (feeding destination) setting screen for document folder illustrated in FIG. 7 on the display 111 (Step S103). On a feeding location setting screen 1301 for document folder, only a specific feeding location is selectable, and other feeding locations are not selectable. In FIG. 7, a first feeding location 1302 indicating the tray 17 is selectable, and a second feeding location 1303 indicating the cassette 10 is not selectable. In FIG. 7, feeding locations which are not selectable are displayed in a different form from the selectable feeding location, and are not activated even when pressed. Through pressing of the select button 1304 after selecting the feeding location, the main controller 101 sets the selected feeding location.

A recording material S having a fixed portion, such as a document folder, can be fed from a feeding location having a conveyance path in which there are few curves, thereby preventing a deterioration in conveyance performance. For this reason, in the first embodiment, only the first feeding location 1302 indicating the tray 17 is selectable as the specific feeding location. That is, the tray 17 is suitable for feeding a recording material S which is a document folder, and the cassette 10 is not suitable for feeding a recording material S which is a document folder.

The main controller 101 displays a guide screen showing a precaution for printing on the recording material S (document folder) illustrated in FIG. 8 on the display 111 (Step S104). A guide screen 1601 provides guidance for preventing creasing, which is a type of conveyance failure that occurs during a printing operation, of a recording material S that has one or more sides having a folded portion which is formed by folding a sheet material, such as a document folder. Specifically, the guide screen 1601 shows a message prompting the user to place the document folder on the tray 17 with the folded portion of the document folder as the leading edge side in the conveyance direction.

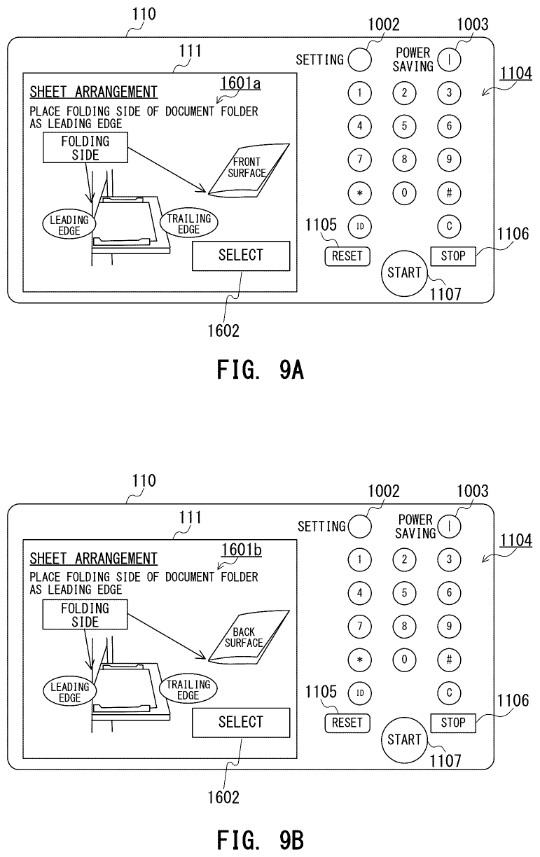

FIG. 9A and FIG. 9B are views of a modification example of the guide screen. Guide screens 1601a and 1601b in FIG. 9A and FIG. 9B include an instruction for the printing surface in addition to the instruction to place the folded portion of the document folder to be placed on the tray 17 as the leading edge side in the conveyance direction. Here, the printing surface is referred to as “front surface.”

The guide screen 1601a of FIG. 9A includes a message prompting the user to place the document folder so that the front surface is facing upward, with the folded portion of the document folder as the leading edge side in the conveyance direction. The image forming apparatus 100 prints an image while conveying the recording material S along the horizontal path extending in the horizontal direction. In this case, the image is printed on the front surface of the document folder by placing the document folder on the tray 17 with the front surface, which is the printing surface, facing upward.

The guide screen 1601b of FIG. 9B includes a message prompting the user to place the document folder so that the back surface is facing upward, with the folded portion of the document folder as the leading edge side in the conveyance direction. The image forming apparatus 201 prints an image while conveying the recording material S along the vertical path extending in the vertical direction. In this case, the image is printed on the front surface of the document folder by placing the document folder on the tray 236 with the front surface, which is the printing surface, facing downward.

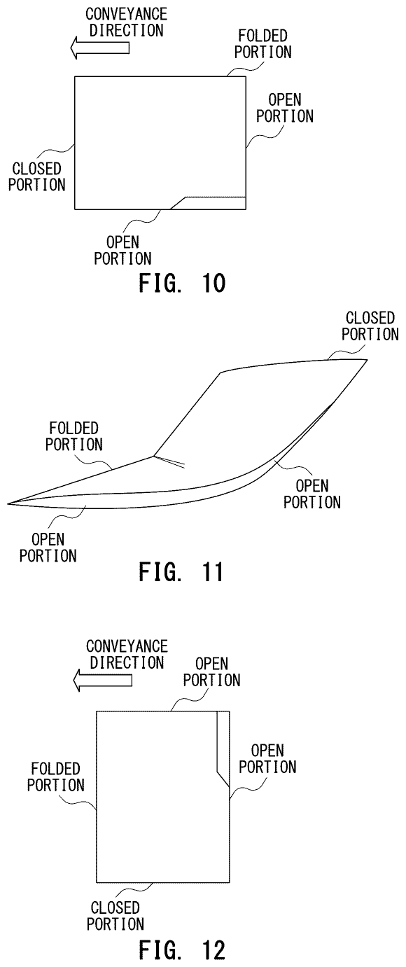

FIG. 10 and FIG. 11 are explanatory diagrams of creasing of the document folder. In FIG. 10, the document folder is placed on the tray 17 so that the folded portion is parallel to the conveyance direction. The conveyance path from the tray 17 to the secondary transfer unit T2 has a smaller curvature of the bent portion than the conveyance path from the cassette 10 to the secondary transfer unit T2. However, even when the document folder is fed from the tray 17, depending on the angle at which the document folder is fed by the feed rollers 13 and the curvature of the local bent portion of the conveyance path, there is a possibility that creasing may occur in the document folder.

The folded portion of the document folder is a fixed portion formed by folding one sheet, and is formed by plastic deformation of one sheet. A folded portion formed in this manner has less elasticity than before the sheet is folded. For this reason, a document folder is susceptible to bending in the perpendicular direction orthogonal to the folded portion, as illustrated in FIG. 11, and may become creased.

FIG. 12 is an explanatory diagram of a placement state on the tray 17 of a document folder in which the occurrence of a crease is prevented. The image forming apparatus 100 is designed based on the premise of stably conveying a sheet-like recording material S, and thus the curvature in the perpendicular direction is smaller than in the conveyance direction. Therefore, when conveying a document folder having a folded portion in the image forming apparatus 100, the document folder is placed on the tray 17 so that the folded portion is perpendicular to the conveyance direction. With such a placement state, the curvature of the bend with respect to the folded portion becomes small.

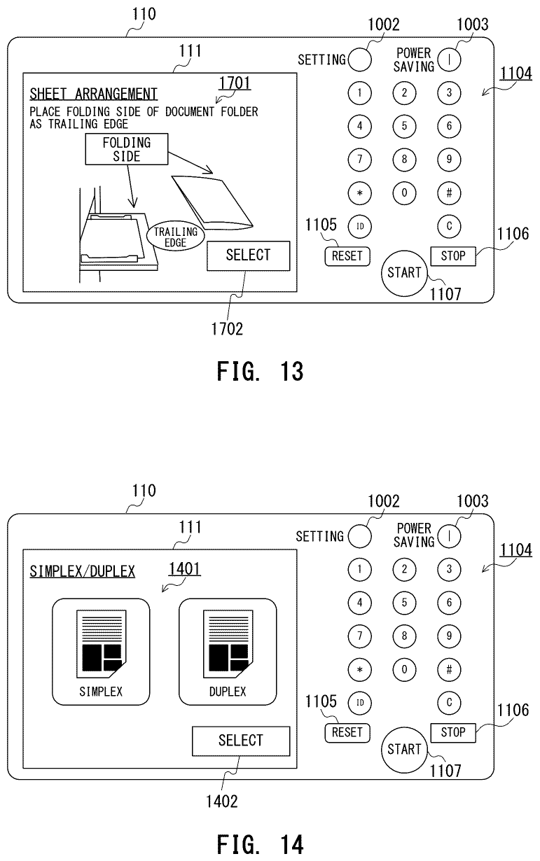

In a case where the user presses the select button 1602 after checking the guide screens 1601, 1601a, and 1601b in FIG. 8 or FIG. 9A and FIG. 9B, the display of the guide screens 1601, 1601a, and 1601b ends, and the various setting processing steps for executing the image forming operation can continue to be performed. The guide screens are not limited to the screens illustrated in FIG. 8, FIG. 9A, and FIG. 9B. FIG. 13 is an exemplary view of a guide screen for illustrating another precaution. A guide screen 1701 includes a message prompting the user to place the recording material S on the tray 17 so that the folded portion is perpendicular to the conveyance direction and the folded portion is the trailing edge in the conveyance direction. In this case, when the user presses the select button 1702 after checking the guide screen 1701 of FIG. 13, the display of the guide screen 1701 ends, and the various setting processing steps for executing the image forming operation can continue to be performed.

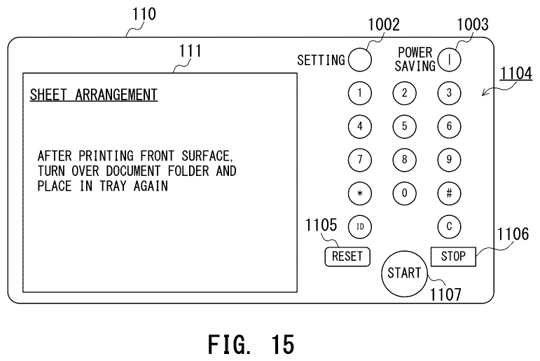

When the display of the guide screen ends, the main controller 101 displays the simplex/duplex setting screen illustrated in FIG. 14 on the display 111 (Step S105). The user selects simplex printing or duplex printing from the simplex/duplex setting screen 1401 by using the operation unit 110, and presses the select button 1402. The selection content is transmitted from the operation unit 110 to the main controller 101. The main controller 101 sets any one of simplex printing and duplex printing in accordance with the selection content acquired from the operation unit 110.

The main controller 101 determines whether or not simplex printing is set (Step S106). In a case where simplex printing is set (Step S106: Y), the main controller 101 completes the settings required for sheet passage. In this case, the type of recording material S is set to document folder, the feeding location is set to tray 17, and simplex printing is set. In a case where the start key 1107 of the operation unit 110 is pressed, the main controller 101 starts a job based on “manual feeding/simplex setting” (Step S107). In a case where duplex printing is set (Step S106: N), the main controller 101 completes the settings required for sheet passage. In this case, the type of recording material S is set to document folder, the feeding location is set to tray 17, and duplex printing is set. In a case where the start key 1107 of the operation unit 110 is pressed, the main controller 101 starts a job based on “manual feeding/duplex setting” (Step S108).

In a case where a job is started based on the “manual feeding/duplex setting,” the conveyance direction of the document folder is reversed by the reversing unit 302, and thus the document folder is conveyed with the open portion as the leading edge. This becomes a cause of jamming. For this reason, in a case where a job is performed based on the “manual feeding/duplex setting,” the document folder is delivered after an image is printed on the front surface, and is again placed on the tray 17 with the printing surface as the back surface. As a result, jams that occur in a case where the open portion is the leading edge in the conveyance direction can be prevented.

FIG. 15 is an exemplary view of an instruction screen in a case where a job is started based on the “manual feeding/duplex setting.” This instruction screen is displayed on the display 111 at the start of the processing step of Step S108. In a case where the main controller 101 completes printing on the front surface and detects that the document folder has been placed on the tray 17, the main controller 101 erases the instruction screen illustrated in FIG. 15 from the display 111, and performs printing on the back surface.

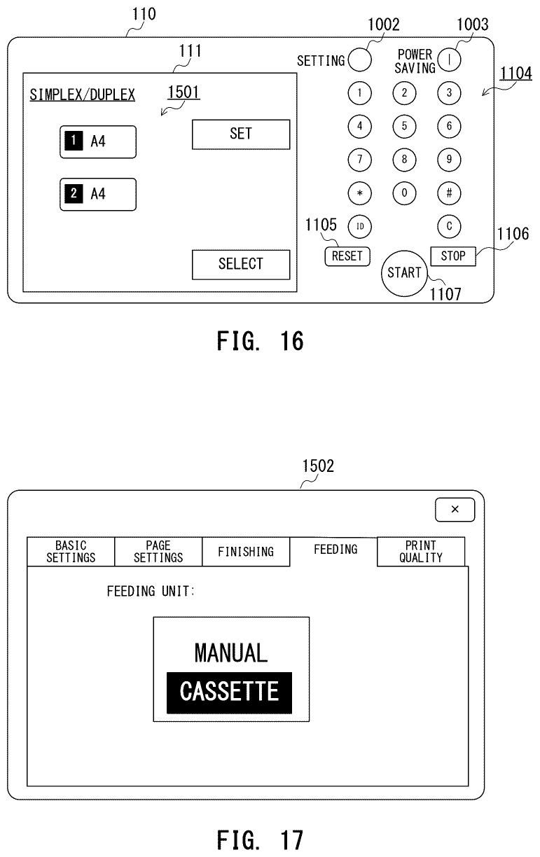

In a case where a type other than document folder is set as the type of the recording material S (Step S102: N), the main controller 101 displays a normal feeding location setting screen illustrated in FIG. 16 on the display 111 (Step S109). A normal feeding location setting screen 1501 is a screen in which all feeding locations are selectable. In FIG. 16, both of the first feeding location indicating the tray 17 and the second feeding location indicating the cassette 10 are selectable. In a case where the select button is pressed after the feeding location is selected, the main controller 101 sets the selected placement portion 124 (feeding location).

The main controller determines whether or not the set feeding location is set to the tray 17 (manual feeding) (Step S110). In a case where manual feeding is set (Step S110: Y), the main controller 101 displays the simplex/duplex setting screen illustrated in FIG. 14 on the display 111 (Step S111). Any one of simplex printing and duplex printing is set in the same manner as the processing step of Step S105 by using the simplex/duplex setting screen.

The main controller 101 determines whether or not simplex printing is set (Step S112). In a case where simplex printing is set (Step S112: Y), the main controller 101 completes the settings required for sheet passage. In this case, the type of recording material S is set to other than document folder, the feeding location is set to tray 17, and simplex printing is set. In a case where the start key 1107 of the operation unit 110 is pressed, the main controller 101 starts a job based on “manual feeding/simplex setting” (Step S113). In a case where duplex printing is set (Step S112: N), the main controller 101 completes the settings required for sheet passage. In this case, the type of recording material S is set to other than document folder, the feeding location is set to tray 17, and duplex printing is set. In a case where the start key 1107 of the operation unit 110 is pressed, the main controller 101 starts a job based on “manual feeding/duplex setting” (Step S114). In this case, the recording material S is not a document folder, and thus duplex printing is performed reversing the conveyance direction of the recording material S by the reversing unit 302.

In a case where the set feeding location is set to the cassette 10 (Step S110: N), the main controller 101 displays the simplex/duplex setting screen illustrated in FIG. 14 on the display 111 (Step S115). Any one of simplex printing and duplex printing is set in the same manner as the processing step of Step S105 by using the simplex/duplex setting screen.

The main controller 101 determines whether or not simplex printing is set (Step S116). In a case where simplex printing is set (Step S116: Y), the main controller 101 completes the settings required for sheet passage. In this case, the type of recording material S is set to other than document folder, the feeding location is set to cassette 10, and simplex printing is set. In a case where the start key 1107 of the operation unit 110 is pressed, the main controller 101 starts a job based on “cassette feeding/simplex setting” (Step S117). In a case where duplex printing is set (Step S116: N), the main controller 101 completes the settings required for sheet passage. In this case, the type of recording material S is set to other than document folder, the feeding location is set to cassette 10, and duplex printing is set. In a case where the start key 1107 of the operation unit 110 is pressed, the main controller 101 starts a job based on “cassette feeding/duplex setting” (Step S118). In this case, the recording material S is not a document folder, and thus duplex printing is performed reversing the conveyance direction of the recording material S by the reversing unit 302.

In the first embodiment, description is given of an example in which various settings related to printing are performed by the user operating the operation unit 110, but it is possible to perform the same processing even when the user operates the external device 1000. The external device 1000 is an information processing device which includes an input device and a display. The external device 1000 has the functions of the main controller 101, and a printer driver for using the image forming system 1X, for example, is installed in the external device 1000. On the display of the external device 1000, the printer driver displays, in accordance with the progress of the processing, screens for selecting the items to be set on each of the screens of FIG. 5, FIG. 7, FIG. 14, and FIG. 16. Further, the guide screen shown in FIG. 8, FIG. 9A and FIG. 9B, or FIG. 13 is also displayed in accordance with the progress of the processing. FIG. 17 is an exemplary view of a feeding location setting screen displayed on a display 1502 of the external device 1000. This selection screen corresponds to the setting screens of FIG. 7 and FIG. 16. Even when setting is performed by using the external device 1000, it is possible to print on the document folder.

In the processing described above, in a case where the recording material S is a document folder, the feeding location is restricted to the tray 17, and guidance relating to the orientation of the document folder when placed on the tray 17 is also provided. As a result, the occurrence of a crease during conveyance of the recording material S (document folder) is prevented. In this way, even when the user prints an image on a document folder for the first time, the user can appropriately know the feeding location and orientation during placement.

### Second Embodiment

In the first embodiment, the occurrence of a crease in the recording material S (document folder) is prevented by limiting the feeding location and issuing a precaution regarding the orientation of the recording material S during placement. In a second embodiment of the present disclosure, description is given of a case in which jamming, which is another conveyance failure caused by the characteristics of document folders, is prevented.

In a case where a document folder is conveyed with an open portion of the document folder as the leading edge side in the conveyance direction, the unfixed side of the open portion may open during conveyance, which can reduce the conveyance speed and cause a conveyance failure such as jamming to occur. In order to pass a recording material S having an open portion without jamming, it is required to set a fixed portion as the leading edge side in the conveyance direction in a case where the recording material S is placed in the feeding location, and to not reverse the conveyance direction by the reversing unit 302. The fixed portion has a plurality of overlapping sides (edges) fixed to each other, and is provided, for example, on two or more of the long sides and the short sides of the document folder.

In the second embodiment, in a case where a document folder is selected as the recording material S, like in the first embodiment, a fixed portion is set as the leading edge side in the conveyance direction by issuing a precaution regarding the orientation during placement of the recording material S. Further, by not performing duplex printing and permitting only simplex printing, and prohibiting guidance of the recording material S to the conveyance path 301, reversing of the conveyance direction by the reversing unit 302 is not performed. As a result of those measures, jamming in a case where a document folder is selected as the recording material S is prevented.

In the second embodiment, even in simplex printing, in a case where the recording material S is delivered by reversing the printing surface, the recording material S is preliminarily guided to the reversing unit 302. Whether or not to determine the printing surface and deliver the recording material S can be set as appropriate, and thus for a document folder reversing of the printing surface is not performed.

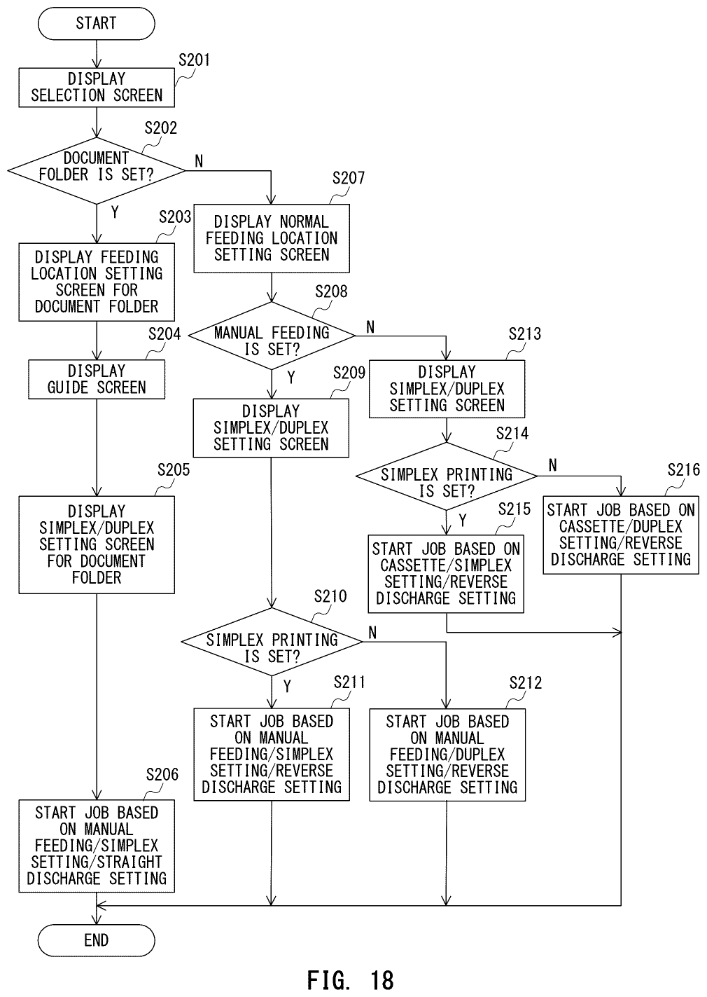

FIG. 18 is a flowchart for illustrating processing from setting of the sheet type to starting image formation. Here, description is given of processing executed in a case where the image forming apparatus 100 is used, but the same processing is possible in a case where the image forming apparatus 201 is used.

The type of the recording material S is set and whether the set type is a document folder is determined by performing the same processing steps as Step S101 and Step S102 of FIG. 6 (Step S201 and Step S202). In a case where the set type is a document folder (Step S202: Y), the main controller 101 displays the feeding location setting screen 1301 for the document folder illustrated in FIG. 7 on the display 111 based on the same processing step as Step S103 of FIG. 6 (Step S203).

The main controller 101 displays a guide screen showing a precaution for printing on the recording material S (document folder) illustrated in FIG. 19 on the display 111 (Step S204). A guide screen 1801a includes a message which prompts the user to place the document folder on the tray 17 so that a fixed portion on a long side of the document folder is the leading edge side in the conveyance direction. The guide screen 1801a provides guidance for preventing jamming when passing a recording material S having an open portion, which is a side that is not fixed like a document folder. In a case where the user presses a select button 1802 after checking the guide screen 1801a, the display of the guide screen 1801a ends, and the various setting processing steps for executing the image forming operation can continue to be performed.

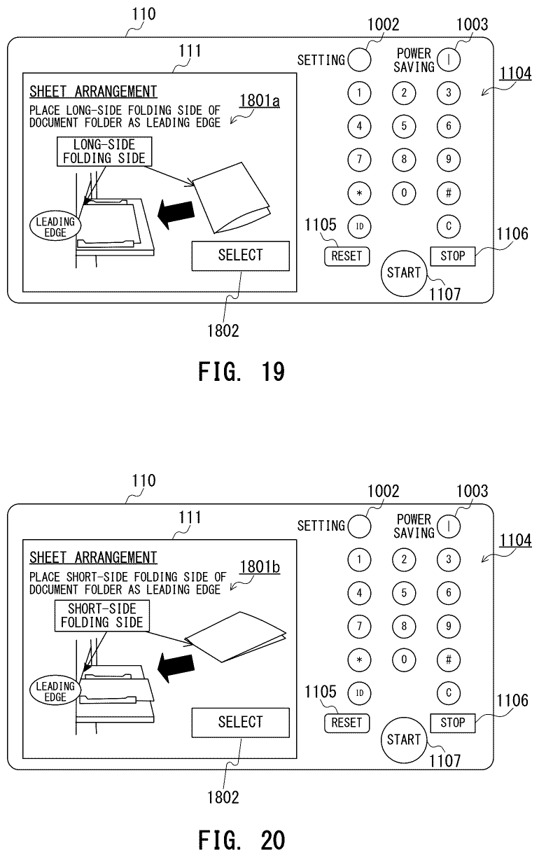

Here, the user is prompted to place the document folder on the tray 17 so that a fixed portion on a long side of the document folder is the leading edge side in the conveyance direction, but the leading edge side in the conveyance direction may be a short side of the document folder. In FIG. 20, there is illustrated an example of the guide screen in this case. During the processing step of Step S204, a guide screen 1801b of FIG. 20 may be displayed on the display 111. Which of the guide screen 1801a of FIG. 19 and the guide screen 1801b of FIG. 20 is to be displayed is determined depending on, for example, the bent portion of the conveyance path of the recording material S.

For example, in a case where the recording material S is conveyed approximately horizontally from the tray 17 along a horizontal path as in the image forming apparatus 100, the occurrence of conveyance failure can be prevented even when a fixed portion on a short side of the document folder is conveyed first. However, for a vertical path like that in the image forming apparatus 201, in a case in which the recording material S is bent from the tray 236 and conveyed in the vertical direction, when a fixed portion on a short side of the document folder is conveyed first, the possibility of conveyance failure is higher than when a fixed portion on a long side is conveyed first. For this reason, for example, the image forming apparatus 100 displays the guide screen 1801b of FIG. 20, and the image forming apparatus 201 displays the guide screen 1801a of FIG. 19.

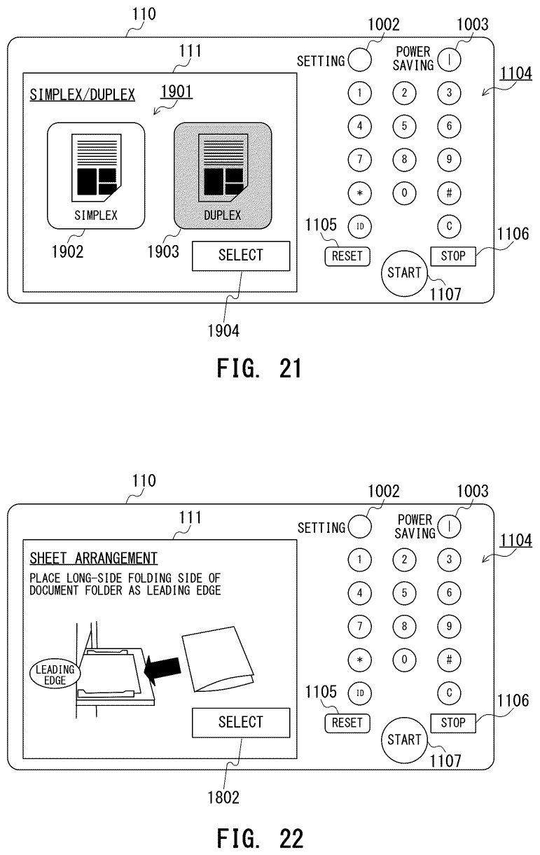

In a case where the display of the guide screens 1801a and 1801b ends, the main controller 101 displays the simplex/duplex setting screen for a document folder illustrated in FIG. 21 on the display 111 (Step S205). On a simplex/duplex setting screen 1901 for a document folder, only a specific setting is selectable. Specifically, only simplex printing 1902 is selectable, and duplex printing 1903 is displayed in a form different from the selectable feeding location as not being selectable. The user selects the simplex printing 1902 from the simplex/duplex setting screen 1901 by using the operation unit 110, and presses a select button 1904. The selection content is transmitted from the operation unit 110 to the main controller 101. The main controller 101 sets simplex printing in accordance with the selection content acquired from the operation unit 110. With a configuration that allows only simplex printing 1902 to be selectable, it is possible to prevent jamming of a recording material S having an open portion, like a document folder.

The main controller 101 completes the settings required for sheet passage in a case where simplex printing is set. In this case, the type of recording material S is set to document folder, the feeding location is set to tray 17, and simplex printing is set. In a case where the start key 1107 of the operation unit 110 is pressed, the main controller 101 starts a job based on “manual feeding/simplex setting/straight discharge setting” (Step S206). The processing steps of from Step S207 to S216 are similar to the processing steps of from Step S109 to S118 of FIG. 6, and thus a description thereof is omitted here.

Similarly to the first embodiment, duplex printing of the document folder is possible by first delivering the document folder having an image printed on the front surface to outside the image forming apparatus 100, and then prompting the user to place the document folder on the tray 17 with the printing surface as the back surface. Therefore, for example, duplex printing may be enabled by displaying the simplex/duplex setting screen of FIG. 14 in the processing step of Step S205, and displaying the instruction screen of FIG. 15 at the start of the job.

Similarly to the first embodiment, it is also possible in the second embodiment for the user to perform various settings relating to printing by operating the external device 1000. On the display of the external device 1000, the printer driver displays, in accordance with the progress of the processing, screens for selecting the items to be set on each of the screens of FIG. 5, FIG. 7, and FIG. 21. Further, the guide screen of FIG. 19 or FIG. 20 is also displayed in accordance with the progress of the processing. Even when the settings are performed by using the external device 1000, it is possible to print on the document folder.

In the processing described above, in a case where the recording material S is a document folder, the feeding location is restricted to the tray 17, guidance relating to the orientation of the document folder when placed on the tray 17 is also provided, and only simplex printing is possible. As a result, the occurrence of jamming during conveyance of the recording material S (document folder) is prevented. In this way, even when the user prints an image on a document folder for the first time, the user can appropriately know the feeding location and orientation during placement. In addition, not performing duplex printing and permitting only simplex printing, and prohibiting guidance of the recording material S to the reversing unit 302, may be introduced into the first embodiment.

### Third Embodiment

In the first embodiment, the occurrence of creasing of the recording material S (document folder) is prevented by limiting the feeding location and the orientation of the recording material S during placement. In the second embodiment, the occurrence of jamming is prevented by limiting the orientation of the recording material S during conveyance. In a third embodiment of the present disclosure, description is given of an example in which those embodiments are combined.

In this case, a guide screen prompting the user to place the document folder on the tray 17 with a fixed portion of a long side of the document folder as the leading edge side in the conveyance direction is displayed on the display 111. In FIG. 22, there is illustrated the guide screen in this case. This guide screen is displayed on the display 111 in the processing step of Step S104 in FIG. 6 or the processing step of Step S204 in FIG. 18. Similarly to the second embodiment, duplex printing may be prohibited in a case where the recording material S is a document folder, or duplex printing may be possible by performing simplex printing twice in the same manner as in the first embodiment.

Similarly to the first embodiment and the second embodiment, in the third embodiment as well, the user can perform various settings relating to printing by operating the external device 1000. The printer driver displays the guide screen of FIG. 22 on the display of the external device 1000 in accordance with the progress of the processing. Even when setting is performed by using the external device 1000, it is possible to print on the document folder.

In the processing described above, in a case where the recording material S is a document folder, the feeding location is restricted to the tray 17, and guidance relating to the orientation of the document folder when placed on the tray 17 is also provided. As a result, the occurrence of a crease and jamming during conveyance of the recording material S (document folder) is prevented. In this way, even when the user prints an image on a document folder for the first time, the user can appropriately know the feeding location and orientation during placement.

As described in the first embodiment, the second embodiment, and the third embodiment, in the at least one embodiment, the possibility of occurrence of conveyance failure of the recording material can be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-064418, filed Apr. 12, 2024, which is hereby incorporated by reference herein in its entirety.

What is claimed is:

1. An image forming apparatus comprising:
a selector configured to select a first mode for forming an image on a first recording material including a first side which is closed, a second side which is closed, a third side which is open, and a fourth side which is open;
a placement portion on which the first recording material is to be placed;
an image former configured to form an image on the first recording material conveyed from the placement portion; and
a display,
wherein the display is configured to display, in a case where the first mode is selected by the selector, a message prompting a user to place the first recording material on the placement portion so that a leading edge side of the first recording material in a conveyance direction becomes the first side.

2. The image forming apparatus according to claim 1, wherein the first side is longer than the second side.

3. The image forming apparatus according to claim 1,
wherein the first side is formed by folding a sheet material of the first recording material, and
wherein the second side is formed by closing sides which overlap in a case where the sheet material is folded.

4. The image forming apparatus according to claim 1, further comprising:
a conveyance path extending in a perpendicular direction orthogonal to a lower surface of the image forming apparatus; and
a conveyance unit configured to convey the first recording material from the placement portion to the image former by conveying the first recording material from a lower side of the conveyance path toward an upper side of the conveyance path,
wherein the display is configured to display, in a case where the first mode is selected by the selector, a message prompting the user to place the first recording material on the placement portion so that a printing surface of the first recording material faces downward.

5. The image forming apparatus according to claim 1, further comprising:
a conveyance path extending in a horizontal direction parallel to a lower surface of the image forming apparatus; and
a conveyance unit configured to convey the first recording material from the placement portion to the image former via the conveyance path,
wherein the display is configured to display, in a case where the first mode is selected by the selector, a message prompting the user to place the first recording material on the placement portion so that a printing surface of the first recording material faces upward.

6. The image forming apparatus according to claim 1, further comprising:
a duplex-printing conveyance path configured to reverse a recording material having an image printed on a first surface by the image former, and to convey the recording material to the image former again;
a delivery portion configured to receive delivery of the recording material; and
a conveyance unit configured to convey the recording material,
wherein the conveyance unit is configured to deliver, in a case where the first mode is selected by the selector and duplex printing is set, after the image former prints an image on the first surface of the first recording material, the first recording material to the delivery portion without guiding the first recording material along the duplex-printing conveyance path.

7. The image forming apparatus according to claim 6, wherein the display is configured to display a message prompting the user to place the first recording material delivered to the delivery portion on the placement portion in a second orientation which is reversed from a first orientation used in a case where the first recording material is placed on the placement portion in order to print an image on the first surface.

8. The image forming apparatus according to claim 1,
wherein the placement portion includes a tray and a cassette,
wherein a first curvature of a first conveyance path from the tray to the image former is less than a second curvature of a second conveyance path from the cassette to the image former, and
wherein the display is configured to display, in a case where the first mode is selected by the selector, a setting screen on which the tray is settable as a feeding destination for the first recording material.

9. The image forming apparatus according to claim 2, wherein the display is configured to display a message prompting the user to place the first recording material on the placement portion so that the first side of the first recording material is perpendicular to the conveyance direction.

10. The image forming apparatus according to claim 1, wherein the display is configured to display, in a case where the first mode is selected by the selector, a setting screen on which only simplex printing is settable.

11. The image forming apparatus according to claim 1, wherein the first recording material is a document folder formed into a bag shape by folding a plastic sheet material.

12. The image forming apparatus according to claim 1, wherein the display is configured to avoid displaying the message in a case where a second mode for forming an image on a second recording material which is free of a closed side is selected by the selector.

13. An information processing device which is operable to communicate with an image forming apparatus including: a placement portion on which a recording material is to be placed; and an image former configured to form an image on the recording material conveyed from the placement portion, the information processing device comprising:
a selector configured to select a first mode for forming an image on a first recording material including a first side which is closed, a second side which is closed, a third side which is open, and a fourth side which is open; and
a display,
wherein the display is configured to display, in a case where the first mode is selected by the selector, a message prompting a user to place the first recording material on the placement portion so that a leading edge side of the first recording material in a conveyance direction becomes the first side.

14. The information processing device according to claim 13,
wherein the image forming apparatus further includes:
a conveyance path extending in a perpendicular direction orthogonal to a lower surface of the image forming apparatus; and
a conveyance unit configured to convey the first recording material from the placement portion to the image former by conveying the first recording material from a lower side of the conveyance path toward an upper side of the conveyance path, and
wherein the display is configured to display, in a case where the first mode is selected by the selector, a message prompting the user to place the first recording material on the placement portion so that a printing surface of the first recording material faces downward.

15. The information processing device according to claim 13:
wherein the image forming apparatus further includes:
a conveyance path extending in a horizontal direction parallel to a lower surface of the image forming apparatus; and
a conveyance unit configured to convey the first recording material from the placement portion to the image former via the conveyance path, and
wherein the display is configured to display, in a case where the first mode is selected by the selector, a message prompting the user to place the first recording material on the placement portion so that a printing surface of the first recording material faces upward.

16. The information processing device according to claim 13,
wherein the image forming apparatus further includes:
a duplex-printing conveyance path configured to reverse a recording material having an image printed on a first surface by the image former, and to convey the recording material to the image former again; and
a delivery portion configured to receive delivery of the recording material, and
wherein the display is configured to display, in a case in which the image forming apparatus delivers, when performing duplex printing on the first recording material, after the image former prints an image on the first surface of the first recording material, the first recording material to the delivery portion without guiding the first recording material along the duplex-printing conveyance path, a message prompting the user to place the first recording material delivered to the delivery portion on the placement portion in a second orientation which is reversed from a first orientation used in a case where the first recording material is placed on the placement portion in order to print an image on the first surface.

17. The information processing device according to claim 13,
wherein the placement portion of the image forming apparatus includes a tray and a cassette,
wherein a first curvature of a first conveyance path from the tray to the image former is set to be less than a second curvature of a second conveyance path from the cassette to the image former, and
wherein the display is configured to display, in a case where the first mode is selected by the selector, a setting screen on which the tray is settable as a feeding destination for the first recording material.

18. The information processing device according to claim 13,
wherein the first side is longer than the second side, and
wherein the display is configured to display a message prompting the user to place the first recording material on the placement portion so that the first side of the first recording material is perpendicular to the conveyance direction.

19. The information processing device according to claim 13, wherein the display is configured to display, in a case where the first mode is selected by the selector, a setting screen on which only simplex printing is settable.

20. The information processing device according to claim 13, wherein the display is configured to avoid displaying the message in a case where a second mode for forming an image on a second recording material which is free of a closed side is selected by the selector.
